(19) United States
(12) Patent Application Publication
(10) Pub. No.: US 2025/0227645 A1
(43) Pub. Date: Jul. 10, 2025

(54) METHOD FOR PROVIDING SERVICE THROUGH ALTERNATIVE SLICE

(71) Applicant: SAMSUNG ELECTRONICS CO., LTD., Suwon-si (KR)

(72) Inventors: Dongeun SUH, Suwon-si (KR); Hoyeon LEE, Suwon-si (KR)

(21) Appl. No.: 19/011,454

(22) Filed: Jan. 6, 2025

(30) Foreign Application Priority Data
Jan. 5, 2024 (KR) 10-2024-0002393

(51) Int. Cl. H04W 60/00; H04W 76/30

(52) U.S. Cl. CPC H04W 60/00; H04W 76/30

(57) ABSTRACT

The disclosure relates to a 5G or 6G communication system for supporting a higher data transmission rate. A method by an access and mobility management function (AMF) in a wireless communication system, according to an embodiment, may comprise, when processing at least one protocol data unit (PDU) session included in a network slice for service continuity, determining a PDU session to be released in the network slice among the at least one PDU session and transmitting a release request message including a PDU session identifier corresponding to the PDU session to be released in the network slice to a session management function (SMF).

### CROSS-REFERENCE TO RELATED APPLICATION

This application is based on and claims priority under 35 U.S.C. § 119 to Korean Patent Application No. 10-2024-0002393, which was filed in the Korean Intellectual Property Office on Jan. 5, 2024, the entire disclosure of which is incorporated herein by reference.

### BACKGROUND

### 1. Field

The present disclosure provides a method for a service considering the availability of a network slice replaced in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

There may be instances where one or all of the protocol data unit (PDU) sessions included in any network slice need to be moved to another network slice. For example, when congestion occurs among various 5G network entities belonging to the network slice, one or all of the PDU sessions included in the network slice may need to be moved to another network slice. For example, when use of a particular slice should be temporarily or permanently stopped for operational reasons (e.g., equipment replacement and/or upgrades), one or all of the PDU sessions included in the network slice may need to be moved to another network slice. For example, when corresponding traffic needs to be moved to another slice due to deterioration of performance of the network slice transmitting application traffic, one or all of the PDU sessions included in the network slice may need to be moved to the other network slice.

### SUMMARY

The present disclosure relates to a method for performing a transmission/reception through an alternative network slice instead of an existing network slice when one or all of the PDU sessions included in the network slice need to be moved to another network slice.

A method by an access and mobility management function (AMF) in a wireless communication system, according to an embodiment, may comprise, when processing at least one protocol data unit (PDU) session included in a network slice for service continuity, determining a PDU session to be released in the network slice among the at least one PDU session and transmitting a release request message including a PDU session identifier corresponding to the PDU session to be released in the network slice to a session management function (SMF).

An access and mobility management function (AMF) in a wireless communication system according to an embodiment comprises a transceiver and a controller. The controller may, when processing at least one protocol data unit (PDU) session included in a network slice for service continuity, determine a PDU session to be released in the network slice among the at least one PDU session and control to transmit a release request message including a PDU session identifier corresponding to the PDU session to be released in the network slice to a session management function (SMF).

A method and device according to an embodiment may provide service continuity by performing transmission/reception through an alternative network slice instead of an existing network slice when one or all of the PDU sessions included in the network slice need to be moved to another network slice.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates a 5G system according to an embodiment of the present disclosure;

FIGS. 2A and 2B illustrate a method for processing an associated PDU session based on the availability of a network slice replaced in a registration procedure and providing UE configuration information according to an embodiment of the present disclosure;

FIG. 3 illustrates a method for processing an associated PDU session based on the availability of a network slice replaced in a UE configuration update procedure and providing UE configuration information according to an embodiment of the present disclosure;

FIG. 4 illustrates a method for a replaced network slice according to the location of a UE in a handover procedure according to an embodiment of the present disclosure;

FIG. 5 illustrates a UE according to an embodiment of the present disclosure; and

FIG. 6 illustrates a network entity according to an embodiment of the present disclosure.

### DETAILED DESCRIPTION

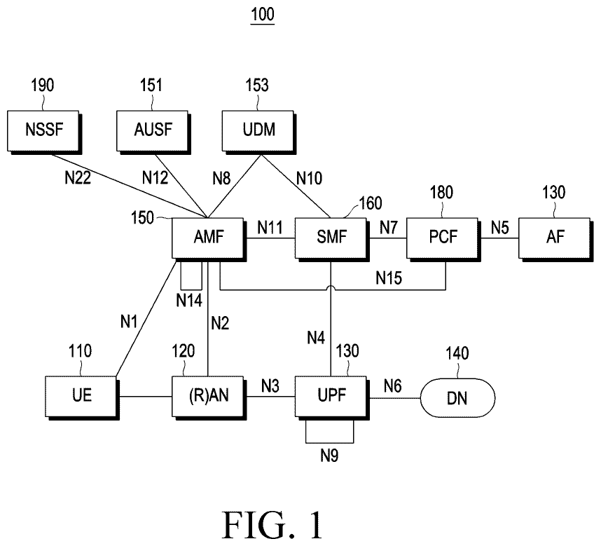

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operational principle of the disclosure is described below with reference to the accompanying drawings. The terms described below are ones defined considering functions in the disclosure. Since the terms may be varied according to the user's or operator's intent or custom, their definitions should be determined according to the contents throughout the disclosure.

The terms referring to network entities or network function entities as used herein, the terms referring to messages, and the term referring to identification information are provided as an example for ease of description. Thus, the disclosure is not limited by the terms, and such terms may be replaced with other terms denoting objects with equivalent technical concept.

Although terms and names as defined in the 5G system standard are used herein for ease of description, embodiments of the disclosure are not limited thereto or thereby, and the same may apply likewise to systems conforming to other standards.

FIG. 1 illustrates a 5G system according to an embodiment of the present disclosure.

Referring to FIG. 1, a 5G system (or 5G mobile communication network) may include a user equipment (UE, or a terminal) 110, a radio access network (RAN, a base station, a gNB (5g nodeB), or an evolved nodeB (eNB)) 120, and a 5G core network.

The 5G core network may include at least one of an application function (AF) 130, a data network (DN) 140, an access and mobility management function (AMF) 150 providing a mobility management function of the UE 110, an authentication server function (AUSF) 151, a unified data management (UDM) 153 providing a data management function, such as of subscriber data and policy control data, a session management function (SMF) 160 providing a session management function, a user plane function (UPF) 170 performing a data transfer role, a policy control function (PCF) 180 providing a policy control function, a unified data management (UDM) 153 providing a data management function such as of subscriber data and policy control data, and a network slice selection function (NSSF) 190. The 5G core network may further include network functions, such as unified data repository (UDR), for storing data of various network functions such as UDM.

In the 3GPP system, a conceptual link connecting NFs in the 5G system is defined as a reference point. Example reference points included in the 5G system architecture represented in FIG. 1 are provided as follows:
N1: the reference point between the UE and the AMF;
N2: Reference point between (R)AN and AMF;
N3: Reference point between (R)AN and UPF;
N4: Reference point between SMF and UPF;
N5: Reference point between PCF and AF;
N6: Reference point between UPF and DN;
N7: Reference point between SMF and PCF;
N8: the reference point between the UDM and the AMF;
N9: Reference point between two core UPFs;
N10: Reference point between UDM and SMF;
N11: Reference point between AMF and SMF;
N12: Reference point between AMF and AUSF;
N13: the reference point between UDM and authentication server function (AUSF);
N14: the reference point between two AMFs; and/or
N15: the reference point between PCF and AMF in non-roaming scenario and reference point between PCF in visited network and AMF in roaming scenario.

In the 5G system, network slicing is a technique and structure that enables several virtualized, independent, logical networks in one physical network. The network operator configures a virtual end-to-end network called a network slice and provides service to meet specified requirements for the service and/or application. The network slice may be identified by an identifier called single-network slice selection assistance information (S-NSSAI). The network transmits a set of allowed slices (e.g., allowed NSSAI(s)) to the UE in a UE registration procedure, and the UE may transmit and/or receive application data through the protocol data unit (PDU) session generated through one S-NSSAI (i.e., network slice) among the allowed NSSAI(s).

In the 5G system, when the UE registers in the network, the UE transmits identifier information (i.e., requested S-NSSAIs) about the network slices to be requested to the AMF, and the AMF may provide information (allowed NSSAI) about the network slices usable by the UE to the UE considering at least one of the requested S-NSSAIs and subscriber information. Even if the UE does not provide the information about the network slices requested by the UE, the AMF may provide the UE with the allowed NSSAI. in this case, the allowed NSSAI may include information about the network slices set as default (i.e., default subscribed S-NSSAIs) among information about default configuration slices (default configured NSSAI) and subscription network slices included in the UE subscriber information.

When no slice may be included in the allowed NSSAI (e.g., when the default configured NSSAI and default subscribed S-NSSAIs are absent or unavailable), the AMF may transmit, to the UE, a network registration reject message including the cause code indicating that registration is rejected due to lack of an available slice.

Meanwhile, when intending to include any slice in the allowed NSSAI of the UE, an admission control (network slice admission control (NSAC)) procedure and an authentication (network slice-specific authentication and authorization (NSSAA)) procedure for the corresponding network slice may be performed. In the NSAC procedure, whether to allow the slice is determined based on the number of UEs currently registered in a particular slice and the maximum number of registered UEs allowed in that slice (i.e., whether to include the slice in the allowed NSSAI). Specifically, the network slice admission control function (NSACF) may monitor the number of registered UEs and the number of established PDU sessions per slice, for the network slices which are the NSAC target and perform control so that the number of registered UEs and the number of established PDU sessions per slice are maintained to be smaller than the maximum number of registered UEs and the maximum number of PDU sessions, respectively.

In this case, when a new UE is registered in the slice which is the NSAC target or when an existing registered UE is deregistered, the AMF may transmit an update request message for indicating the same to the NSACF. When a new PDU session is generated in the slice which is the NSAC target or when an existing PDU session is released, the SMF may transmit an update request message for indicating the same to the NSACF. Upon receiving the message indicating registration of a new UE in the slice or the message indicating generation of a new PDU session, the NSAC may determine whether to allow based on the maximum number of UEs and the maximum number of PDU sessions for the corresponding slice and then include whether to allow in the respective response messages.

In order to transmit/receive data to/from a specific data network (DN) through allowed slices (allowed NSSAIs), the UE may select one of the allowed slices, request to generate a packet data unit (PDU) session to a specific data network name (DNN) in the corresponding slice, and transmit and/or receive data through the generated PDU session. A PDU session includes several traffic flows, and the traffic flows may include two types: a guaranteed bitrate quality-of-service flow (GBR QoS flow) and a non-GBR QoS flow.

A circumstance where the network slice is unavailable may occur (e.g., when congestion occurs among various 5G network entities belonging to any network slice, or when use of a particular slice is temporarily or permanently stopped for operational reasons (e.g., equipment replacement and upgrades), or when corresponding traffic needs to be moved to another slice due to deterioration of performance of the network slice transmitting application traffic), and a function for providing a service through an alternative network slice for service continuity may be provided. Specifically, the network may transmit information (e.g., mapping information) indicating to use an alternative S-NSSAI instead of the S-NSSAI to the UE to replace the S-NSSAI being used by the UE with the alternative S-NSSAI (i.e., the alternative S-NSSAI).

Meanwhile, when the replaced S-NSSAI is not supported in the serving cell of the UE or the current tracking area (TA) due to, e.g., a movement of the UE after transmitting the information indicating to use the alternative S-NSSAI instead of the S-NSSAI to the UE, the AMF requires a method for processing the UE's configuration information or the PDU session associated with the replaced S-NSSAI.

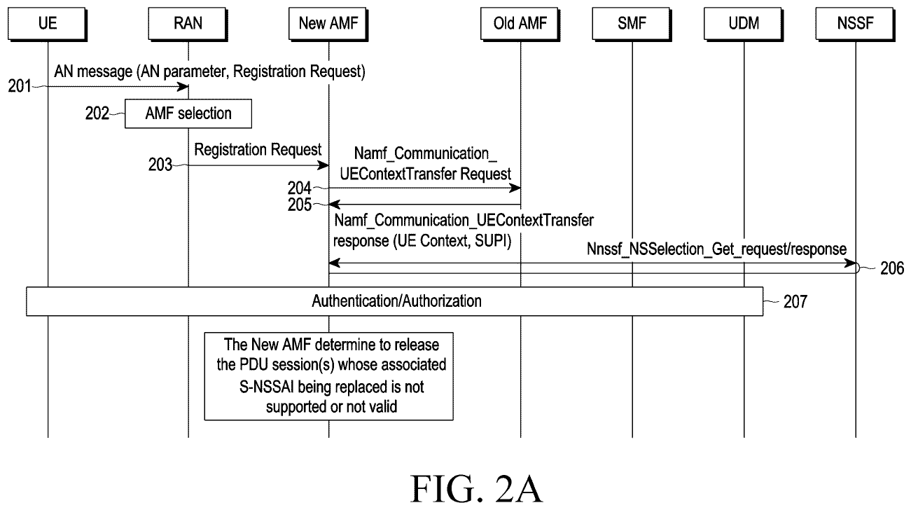

FIGS. 2A and 2B illustrate a method for processing an associated PDU session based on the availability of a network slice replaced in a registration procedure and providing UE configuration information according to an embodiment of the present disclosure.

In step 201, the user equipment (UE) may transmit an AN message (AN parameter, registration request) to the base station (RAN). According to an embodiment, the registration request message may include at least one of a UE identifier (subscription concealed identifier (SUCI), a 5G-globally unique temporary identity (5G-GUTI), or a permanent equipment identifier (PEI)), a registration type, a requested NSSAI, a UE mobility management (MM) core network capability, a list of PDU sessions to be activated, and a PDU session status.

When providing a function for performing slice access control based on the location (e.g., cell ID) of the UE and slice available area information, the UE may include information indicating that the slice available area information of the UE is supported in the UE MM core network capability of the registration request message.

In step 202, the RAN may select the AMF based on the information in the AN message received from the UE.

In step 203, the RAN may transmit an N2 message (N2 parameter, registration request) to the AMF. According to an embodiment, the N2 parameter may include at least one of a selected PLMN ID, UE location information (e.g., location information and the cell ID (e.g., NG-RAN CGI) associated with the cell where the UE is camping), and a UE context request. According to an embodiment, an RAN ID may be included in the N2 message.

Steps 204 and 205 may be omitted when the UE's previous AMF does not exist (e.g., when the registration request is an initial registration request), or when the AMF is not changed.

In step 204, when the AMF is changed, the new AMF may identify the old AMF for the UE based on the 5G-GUTI included in the information received in step 3. The new AMF may transmit a Namf_communication_UEContextTransfer Request message to the old AMF. According to an embodiment, the Namf_Communication_UEContextTransfer Request message may include at least one of the UE's access type and the UE's identifier (e.g., 5G-GUTI or SUPI), or supported features. The supported features may include information about functions supported by the NF (here, the new AMF).

When the new AMF supports a network slice replacement function, the AMF may include the corresponding information in the supported features and, if not, the AMF may not include the corresponding information in the supported features.

The old AMF may determine whether the new AMF supports network slice replacement. For example, the old AMF may determine whether the new AMF supports network slice replacement based on the supported features included in the message received from the new AMF. When the supported features do not include information indicating that the network slice replacement is supported, the old AMF may determine that the new AMF does not support network slice replacement.

When the old AMF determines that the new AMF does not support network slice replacement, the AMF may identify replaced PDU sessions (e.g., PDU sessions associated with the alternative S-NSSAI and S-NSSAI, PDUs associated with two S-NSSAIs, mapping of alternative S-NSSAI, etc.). The old AMF may exclude the network slice replacement related information from the UE context transmitted to the new AMF.

The old AMF may include the alternative S-NSSAI in the UE context.

In step 205, upon receiving the message in step 4, the old AMF may include the UE context and SUPI for the UE identifier included in the received message in the response message to the new AMF.

According to an embodiment, the UE context information transmitted by the old AMF to the new AMF may include S-NSSAI-specific slice available area information for the UE. The S-NSSAI-specific slice available area information (e.g., NS-AoS or S-NSSAI location availability information) may include area information for using the corresponding S-NSSAI. The cell identifier (e.g., NG-RAN CGI, etc.) or the TA identifier (e.g., TAI or TAC) may be included.

The UE context information that the old AMF transmits to the new AMF may include replaced S-NSSAI (i.e., S-NSSAI being replaced) and mapped alternative slice information (e.g., alternative S-NSSAI). The corresponding mapping information may be expressed as mapping of alternative S-NSSAI or mapping of S-NSSAI to alternative S-NSSAI.

Further, the UE context information may include information about the replaced PDU sessions (e.g., PDU sessions associated with the alternative S-NSSAI and S-NSSAI, PDU sessions associated with two S-NSSAIs, etc.) (e.g., PDU session ID, S-NSSAI, alternative S-NSSAI, access type, RAT type, SMF ID, PCF ID, etc.).

In step 206, the new AMF may request and receive slice available area information (e.g., NS-AoS or S-NSSAI location availability information) from the NSSF. The slice available area information may not be included in the information received from the old AMF, or the slice available area information may be performed by configuration information or OAM. In this case, the new AMF includes an indicator requesting S-NSSAI and slice available area information in the message requested from the NSSF. When an indicator requesting slice available area information is included in the message received from the new AMF, the NSSF may include S-NSSAI-specific slice available area information for the S-NSSAI(s) included in the message received from the new AMF in the message transmitted to the new AMF.

In step 207, an authentication/authorization procedure for the UE is performed. The AMF may perform the same through an AUSF (not shown).

In step 208, when the UE context is received from the old AMF in step 5, the new AMF identifies whether there are PDU sessions that may not be supported among the PDU session ID(s) included in the UE context. The new AMF may determine not to support the corresponding PDU session(s), e.g., when the replaced S-NSSAI is not supported in the current UE serving cell or TA for the PDU sessions associated with the replaced S-NSSAI and alternative S-NSSAI, or when the replaced S-NSSAI is not valid by the current UE serving cell and S-NSSAI location availability information (e.g., when the UE serving cell is not included in the NS AoS of the replaced S-NSSAI).

A message for indicating the registration status for the corresponding UE context may be transmitted to the old AMF. The new AMF may transmit a Namf_Communication_RegistrationStatusUpdate message to the old AMF.

According to an embodiment, the Namf_Communication_RegistrationStatusUpdate message may contain one or more of the following information:
PDU session ID(s) to be released: The new AMF may include the identifier(s) of the PDU session(s) (or the SM context ID corresponding to the identifier of the PDU session) to be requested to be released among the PDU sessions in the UE context.

When there are PDU sessions that may not be supported by the new AMF or need to be known to the old AMF among the PDU session ID(s) included in the UE context (e.g., when the replaced S-NSSAI is not supported in the current UE serving cell or TA for the PDU sessions associated with the replaced S-NSSAI and the alternative S-NSSAI or when the replaced S-NSSAI is not valid by the current UE serving cell and S-NSSAI location availability information (e.g., when the UE serving cell is not included in the NS AoS of the replaced S-NSSAI)), the new AMF may include the corresponding PDU session identifiers (or SM context ID corresponding to the PDU session identifier). Further, the new AMF updates the session status (i.e., including information about available PDU sessions) (e.g., delete, from the PDU session status, the PDU session IDs of the PDU sessions released as the replaced S-NSSAI is not supported or not valid).
PDU session ID(s) to be deactivated: The new AMF may include the identifier(s) of the PDU session(s) (or the SM Context ID corresponding to the identifier of the PDU session) among the PDU sessions in the UE Context.

When there are PDU sessions that may not be supported by the new AMF or need to be known to the old AMF among the PDU session ID(s) included in the UE context (e.g., when the replaced S-NSSAI is not supported in the current UE serving cell or TA for the PDU sessions associated with the replaced S-NSSAI and the alternative S-NSSAI or when the replaced S-NSSAI is not valid by the current UE serving cell and S-NSSAI location availability information (e.g., when the UE serving cell is not included in the NS AoS of the replaced S-NSSAI)), the new AMF may include the corresponding PDU session identifiers (or SM context ID corresponding to the PDU session identifier).

In step 208a, when the message received from the new AMF in step 7 includes the PDU session ID(s) to be released (or SM context ID(s)), the old AMF transmits an Nsmf_ReleaseSMContext request including the SM context ID of the PDU session to the SMF in charge for each PDU session to release the corresponding PDU session(s). The SMF performs PDU session release for the SM context ID included in the received message. The SMF may transmit an N4 message to the UPF to release the PDU session. The SMF may transmit a response message including the result indication (i.e., the processing result may indicate success or failure) to the old AMF.

When the message received from the new AMF includes the PDU session ID(s) to be released due to NS-AoS in step 207, the old AMF transmits an Nsmf_UpdateSMContext request (SM context ID or PDU session ID, operation type (deactivate)) to the SMF in charge for each PDU session to release the corresponding PDU session(s). When the operation type indicates deactivate in the received message, the SMF performs user plane (UP) deactivation on the SM context ID or PDU session ID of the included PDU session. The SMF may transmit an N4 message to the UPF for UP deactivation of the PDU session. The SMF may transmit a response message including the result indication (i.e., the processing result may indicate success or failure) to the old AMF.

In step 209, the new AMF obtains subscriber information for the UE from the UDM. Further, the new AMF performs registration for access type on the UDM.

In step 210a, the new AMF may determine PDU sessions to be released according to the circumstance of the network slice among the already established PDU sessions (e.g., PDU session ID(s) included in the PDU session status, list of PDU sessions to be activated) and transmit a release request message including the corresponding PDU session identifiers. The new AMF may determine whether to transmit the corresponding message according to configuration information or operator's policy.

When the replaced S-NSSAI of the replaced PDU session (e.g., PDU sessions associated with the alternative S-NSSAI and the replaced S-NSSAI (i.e., S-NSSAI being replaced)) in the current UE cell or TA is not supported (e.g., when the base stations for the corresponding cell, TA, or RA do not support the corresponding S-NSSAI), or not valid by the S-NSSAI location availability (e.g., when the current UE cell or TA is not included in the NS AoS of the replaced S-NSSAI), the new AMF may include the identifier (e.g., PDU session ID or SM context ID) for the corresponding PDU session. Further, the new AMF updates the session status (i.e., including information about available PDU sessions) (e.g., delete, from the PDU session status, the PDU session IDs of the PDU sessions released as the replaced S-NSSAI is not supported or not valid).

The release request message (e.g., Nsmf_ReleaseSMContext request) may include the PDU session ID(s) or SM context ID(s) for the PDU session(s) to be released.

Alternatively, the new AMF may determine PDU sessions to be deactivated (i.e., user plane deactivation) according to the circumstance of the network slice among the already established PDU sessions (e.g., PDU session ID(s) included in the PDU session status, list of PDU sessions to be activated) and transmit an update request message including the corresponding PDU session identifiers. The new AMF may determine whether to transmit the corresponding message according to configuration information or operator's policy.

When the replaced S-NSSAI of the replaced PDU session (e.g., PDU sessions associated with the alternative S-NSSAI and the replaced S-NSSAI (i.e., S-NSSAI being replaced)) in the current UE cell or TA is not supported (e.g., when the base stations for the corresponding cell, TA, or RA do not support the corresponding S-NSSAI), or not valid by the S-NSSAI location availability (e.g., when the current UE cell or TA is not included in the NS AoS of the replaced S-NSSAI), the new AMF may include the identifier (e.g., PDU session ID or SM context ID) for the corresponding PDU session.

The deactivate request message (e.g., Nsmf_UpdateSMContext request) may include the PDU session ID(s) or SM context ID(s) and operation type (deactivate).

In step 210b, when receiving the Nsmf_ReleaseSMContext message in step 10a, the SMF performs PDU session release on the SM context ID included in the corresponding message. The SMF may transmit an N4 message to the UPF to release the PDU session. The SMF may transmit a response message including the result indication (i.e., the processing result may indicate success or failure) to the AMF.

When the Nsmf_UpdateSmContext message is received in step 210a, and the operation type in the corresponding message indicates deactivate, the SMF performs user plane (UP) deactivation on the PDU session ID or SM context ID included in the corresponding message. The SMF may transmit an N4 message to the UPF to perform UP deactivation corresponding to the SM context ID. The SMF may transmit a response message including the result indication (i.e., the processing result may indicate success or failure) to the AMF.

In step 211, the new AMF may transmit a registration accept message to the UE through the RAN.

When updating the PDU session status (e.g., delete the PDU sessions released in step 8a or step 210a from the PDU session status), the new AMF may include the PDU session status in the registration accept message.

The new AMF identifies whether there is a replaced network slice (e.g., the S-NSSAI being replaced) for the UE (e.g., when the mapping of S-NSSAI being replaced to alternative S-NSSAI (or mapping of alternative S-NSSAI) for the UE is stored in, e.g., the UE context), and the replaced S-NSSAI and the corresponding alternative S-NSSAI are supported in the current UE location (current UE cell or TA) (e.g., the base stations for the corresponding cell, TA, or RA support the corresponding S-NSSAI).

When supported, the new AMF may include, in the registration accept message transmitted to the UE, mapping of alternative S-NSSAI (i.e., mapping information indicating that the alternative S-NSSAI is to be used instead of the S-NSSAI) and allowed NSSAI (i.e., allowed NSSAI including the replaced S-NSSAI and the corresponding alternative S-NSSAI).

When the replaced S-NSSAI is not supported in the current UE location (e.g., TA or cell) or RA, the new AMF may remove the replaced S-NSSAI and the corresponding alternative S-NSSAI from the allowed NSSAI and include the allowed NSSAI in the registration accept message transmitted to the UE. When not supported, the new AMF may remove the alternative S-NSSAI corresponding to the replaced S-NSSAI from the configured NSSAI and include the updated configured NSSAI in the registration accept message transmitted to the UE. Additionally, the new AMF may not include, in the registration accept message transmitted to the UE, the mapping of alternative S-NSSAI (i.e., mapping information indicating to use the alternative S-NSSAI instead of S-NSSAI).

When there is the replaced network slice (e.g., S-NSSAI being replaced) for the UE, and the replaced S-NSSAI is the S-NSSAI location availability target (i.e., the network slice where the available area of the S-NSSAI does not fit the TA boundary), if it is valid according to the current UE location and S-NSSAI location availability information (e.g., when the UE's current cell or TA is included in the NS AoS (network slice area of service) of the replaced S-NSSAI), the new AMF may include, in the registration accept message transmitted to the UE, the mapping of alternative S-NSSAI (i.e., mapping information indicating to use the alternative S-NSSAI instead of the S-NSSAI) and the allowed NSSAI (i.e., the allowed NSSAI including the replaced S-NSSAI and the corresponding alternative S-NSSAI).

When the replaced S-NSSAI is not valid according to the current UE location (e.g., TA or cell) and S-NSSAI location availability information (e.g., when the UE's current cell or TA is not included in the NS AoS (network slice area of service) of the replaced S-NSSAI), the new AMF may remove the replaced S-NSSAI and the corresponding alternative S-NSSAI from the allowed NSSAI and include the updated allowed NSSAI in the registration accept message transmitted to the UE. When not supported, the new AMF may remove the alternative S-NSSAI corresponding to the replaced S-NSSAI from the configured NSSAI and include the updated configured NSSAI in the registration accept message transmitted to the UE. Additionally, the new AMF may not include, in the registration accept message transmitted to the UE, the mapping of alternative S-NSSAI (i.e., mapping information indicating to use the alternative S-NSSAI instead of S-NSSAI).

The registration accept message may be transferred to the UE through the RAN.

When the received registration accept message does not include the mapping of alternative S-NSSAI, the UE may delete the stored mapping of alternative S-NSSAI and delete the corresponding alternative S-NSSAI and the S-NSSAI included in the mapping of alternative S-NSSAI from the stored allowed NSSAI.

When the received registration accept message does not include the mapping of alternative S-NSSAI, the UE may delete the corresponding alternative S-NSSAI and the S-NSSAI included in the mapping of alternative S-NSSAI from the stored configured NSSAI.

When the received registration accept message includes the PDU session status, the UE may internally release (i.e., local release) the PDU sessions except for the PDU session ID(s) included in the corresponding PDU session status.

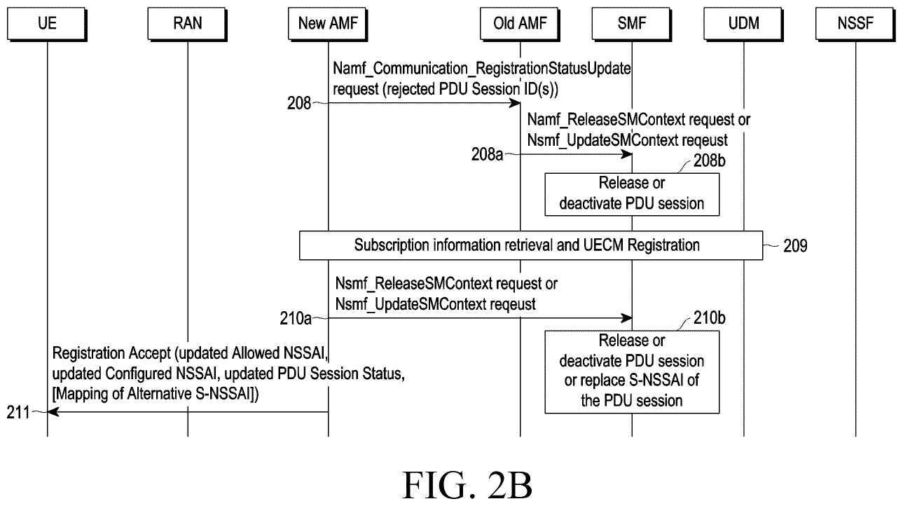

FIG. 3 illustrates a method for processing an associated PDU session based on the availability of a network slice replaced in a UE configuration update procedure and providing UE configuration information according to an embodiment of the present disclosure.

In step 301, the AMF may determine PDU sessions to be released according to the circumstance of the network slice among the already established PDU sessions (e.g., PDU session ID(s) included in the PDU session status, list of PDU sessions to be activated) and transmit a release request message including the corresponding PDU session identifiers. The AMF may determine whether to transmit the corresponding message according to configuration information or operator's policy.

When the replaced S-NSSAI of the replaced PDU session (e.g., PDU sessions associated with the alternative S-NSSAI and the replaced S-NSSAI (i.e., S-NSSAI being replaced)) in the current UE cell or TA is not supported (e.g., when the base stations for the corresponding cell, TA, or RA do not support the corresponding S-NSSAI), or not valid by the S-NSSAI location availability (e.g., when the current UE cell or TA is not included in the NS AoS of the replaced S-NSSAI), the AMF may include the identifier (e.g., PDU session ID or SM context ID) for the corresponding PDU session. Further, the AMF updates the session status (i.e., including information about available PDU sessions) (e.g., delete, from the PDU session status, the PDU session IDs of the PDU sessions released as the replaced S-NSSAI is not supported or not valid).

The release request message (e.g., Nsmf_ReleaseSMContext request) may include the PDU session ID(s) or SM context ID(s) for the PDU session(s) to be released.

In step 302a, when receiving the Nsmf_ReleaseSMContext message in step 1, the SMF performs PDU session release on the SM context ID included in the corresponding message. The SMF may transmit an N4 message to the UPF to release the PDU session. The SMF may transmit a response message including the result indication (i.e., the processing result may indicate success or failure) to the AMF.

When the Nsmf_UpdateSmContext message is received in step 301, and the operation type in the corresponding message indicates deactivate, the SMF performs user plane (UP) deactivation on the PDU session ID or SM context ID included in the corresponding message. The SMF may transmit an N4 message to the UPF to perform UP deactivation corresponding to the SM context ID. The SMF may transmit a response message including the result indication (i.e., the processing result may indicate success or failure) to the AMF.

In step 303, when the PDU session status is updated (e.g., delete the PDU sessions released in step 302a from the PDU session status) or when the replaced network slice for the UE is not supported in the current UE TA or is not valid in the current UE serving cell (e.g., the serving cell is not included in the NS AoS of the replaced S-NSSAI), the new AMF may transmit a UE configuration update message to the UE through the RAN.

When updating the PDU session status (e.g., delete the PDU sessions released in step 208a or step 210a of FIG. 2 from the PDU session status), the new AMF may include the PDU session status in the registration accept message.

The new AMF identifies whether there is a replaced network slice (e.g., the S-NSSAI being replaced) for the UE (e.g., when the mapping of S-NSSAI being replaced to alternative S-NSSAI (or mapping of alternative S-NSSAI) for the UE is stored in, e.g., the UE context), and the replaced S-NSSAI and the corresponding alternative S-NSSAI are supported in the current UE location (current UE cell or TA) (e.g., the base stations for the corresponding cell, TA, or RA support the corresponding S-NSSAI).

When the replaced S-NSSAI is not supported in the current UE location (e.g., TA or cell) or RA, the new AMF may remove the replaced S-NSSAI and the corresponding alternative S-NSSAI from the allowed NSSAI and include the allowed NSSAI in the UE configuration update message transmitted to the UE. When not supported, the new AMF may remove the alternative S-NSSAI corresponding to the replaced S-NSSAI from the configured NSSAI and include the updated configured NSSAI in the UE configuration update message transmitted to the UE. Additionally, the new AMF may not include, in the UE configuration update message transmitted to the UE, the mapping of alternative S-NSSAI (i.e., mapping information indicating to use the alternative S-NSSAI instead of S-NSSAI).

When there is the replaced network slice (e.g., S-NSSAI being replaced) for the UE, and the replaced S-NSSAI is the S-NSSAI location availability target (i.e., the network slice where the available area of the S-NSSAI does not fit the TA boundary), and the replaced S-NSSAI is not valid according to the current UE location (e.g., TA or cell) and S-NSSAI location availability information (e.g., when the UE's current cell or TA is not included in the NS AoS (network slice area of service) of the replaced S-NSSAI), the new AMF may remove the replaced S-NSSAI and the corresponding alternative S-NSSAI from the allowed NSSAI and include the updated allowed NSSAI in the UE configuration update message transmitted to the UE. When not supported, the new AMF may remove the alternative S-NSSAI corresponding to the replaced S-NSSAI from the configured NSSAI and include the updated configured NSSAI in the UE configuration update message transmitted to the UE. Additionally, the new AMF may not include, in the UE configuration update message transmitted to the UE, the mapping of alternative S-NSSAI (i.e., mapping information indicating to use the alternative S-NSSAI instead of S-NSSAI).

The UE configuration update message may be transferred to the UE through the RAN.

When the received UE configuration update message does not include the mapping of alternative S-NSSAI, the UE may delete the stored mapping of alternative S-NSSAI and delete the corresponding alternative S-NSSAI and the S-NSSAI included in the mapping of alternative S-NSSAI from the stored allowed NSSAI.

When the received UE configuration update message does not include the mapping of alternative S-NSSAI, the UE may delete the corresponding alternative S-NSSAI and the S-NSSAI included in the mapping of alternative S-NSSAI from the stored configured NSSAI.

When the received UE configuration update message includes the PDU session status, the UE may internally release (i.e., local release) the PDU sessions except for the PDU session ID(s) included in the corresponding PDU session status.

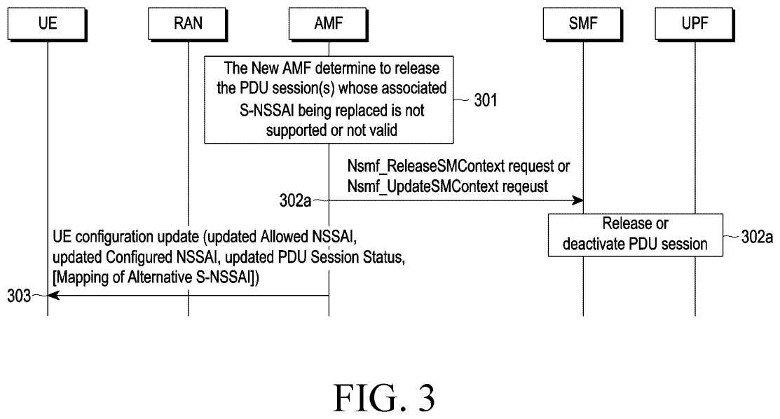

FIG. 4 illustrates a method for providing a replaced network slice according to the location of a UE in a handover procedure according to an embodiment of the present disclosure.

In step 401, an N2-based handover procedure is performed. The S-NG-RAN (source NG-RAN) may transmit a message that handover is required to the S-AMF (i.e., old AMF). The message may include identifier information for PDU sessions served by the S-RAN.

In step 402, when the S-AMF may no longer serve the UE, the S-AMF may select a new T-AMF (i.e., new AMF).

In step 403, the S-AMF may include the UE context for the UE that is the handover target in the message transmitted to the T-AMF.

In step 404, the T-AMF may transmit a message for requesting session handover (e.g., Nsmf_PDUSession_UpdateSMContext (PDU session ID, target ID, T-AMF ID, N2 SM Information)) to the SMF for PDU sessions included in the received UE context (i.e., each PDU session transmitted by the S-RAN). In this case, when the replaced S-NSSAI of the replaced PDU session (e.g., PDU sessions associated with the alternative S-NSSAI and the replaced S-NSSAI (i.e., S-NSSAI being replaced)) in the current UE cell or TA among the PDU sessions included in the UE context is not supported (e.g., when the base stations for the corresponding cell, TA, or RA do not support the corresponding S-NSSAI), or not valid by the S-NSSAI location availability (e.g., when the current UE cell or TA is not included in the NS AoS of the replaced S-NSSAI), the T-AMF may not transmit the SM context update message for the corresponding PDU session to the SMF or may not include the identifier (e.g., PDU session ID or SM context ID) for the corresponding PDU session in the message transmitted to the SMF.

In step 405, if the SMF receives the message of step 4, the SMF may determine whether to accept the handover for the PDU session included in the message of step 404. When accepted, the SMF may transmit an N4 message for handover to the UPF.

In step 406, the SMF may transmit a response message including the processing result (e.g., result indication) for the request message of step 4 to the T-AMF.

In operation 407, the remaining handover procedure may be performed. After the UE is handed over from the S-NG-RAN to the target NG-RAN (T-NG-RAN), the UE may receive services through the T-NG-RAN and the T-AMF.

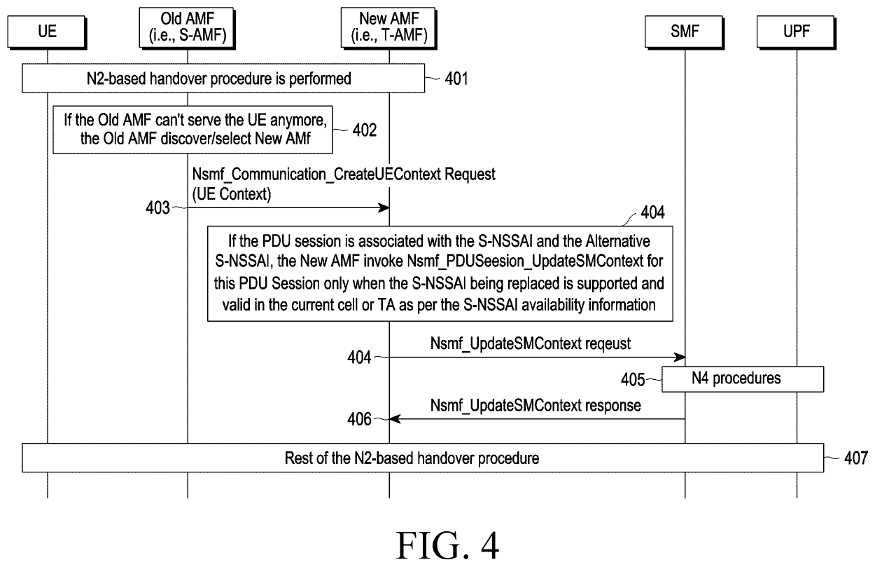

FIG. 5 illustrates a UE according to an embodiment of the present disclosure.

In the embodiment of FIG. 5, the UE may be the UE or terminal shown in each of FIGS. 1 to 4. Referring to FIG. 5, the UE may include a transceiver 510, a controller 520, and a storage 530.

The transceiver 510 may transmit and receive signals to/from a base station or a network entity. The transceiver 510 may transmit/receive data to/from the base station or the network entity using, e.g., wireless communication. In the disclosure, the transceiver 510 may also be referred to as a transmission/reception unit.

The controller 520 may control the overall operation of the UE according to an embodiment. For example, the controller 520 may control the signal flow between the blocks to perform the operations described in connection with FIGS. 1 to 4. In the disclosure, the controller 520 may be defined as a circuit or application-specific integrated circuit or at least one processor.

The storage 530 may store at least one of information transmitted/received via the transceiver 510 and information generated via the controller 520. For example, the storage 530 may store information and data necessary for the method described above with reference to FIGS. 1 to 4.

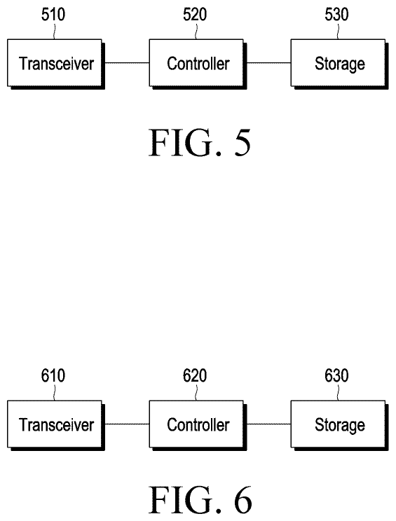

FIG. 6 illustrates a network entity according to an embodiment of the present disclosure.

In the embodiment of FIG. 6, the network entity may be implemented as one of the base station (RAN), AMF (or new AMF or old AMF), SMF, UPF, UDM, or NSSF shown in each of FIGS. 1 to 4. Referring to FIG. 6, the network entity may include a transceiver 610, a controller 620, and a storage 630.

The transceiver 610 may transmit and receive signals to/from the UE, the base station, or another network entity. The transceiver 610 may transmit/receive data to/from the UE, base station or the other network entity using, e.g., wireless communication. In the disclosure, the transceiver 610 may also be referred to as a transmission/reception unit.

The controller 620 may control the overall operation of the network entity according to an embodiment. For example, the controller 620 may control the signal flow between the blocks to perform the operations described in connection with FIGS. 1 to 4. In the disclosure, the controller 620 may be defined as a circuit or application-specific integrated circuit or at least one processor.

The storage 630 may store at least one of information transmitted/received via the transceiver 610 and information generated via the controller 620. For example, the storage 630 may store information and data necessary for the method described above with reference to FIGS. 1 to 4.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first access and mobility management function (AMF) in a wireless communication system, the method comprising:
identifying that a user equipment (UE) moves to a cell where a replaced single network slice selection assistance information (S-NSSAI) is not supported; and
based on the replaced S-NSSAI being not supported, transmitting, to a second AMF, a registration status update message indicating a registration status for a UE context, wherein the registration status update message includes information on protocol data unit (PDU) session identifier (ID) to be released.

2. The method of claim 1, further comprising:
removing the replaced S-NSSAI from an allowed NSSAI in case that the UE moves to the cell where the replaced S-NSSAI is not supported.

3. The method of claim 2, further comprising:
removing an alternative S-NSSAI from the allowed NSSAI in case that the replaced S-NSSAI is not maintained in the allowed NSSAI.

4. The method of claim 3, further comprising:
transmitting, to the UE, a registration accept message including information on an updated allowed NSSAI.

5. The method of claim 1, further comprising:
based on processing at least one PDU session included in a network slice for service continuity, determining a PDU session to be released in the network slice among the at least one PDU session; and
transmitting, to a session management function (SMF), a release request message including the PDU session ID corresponding to the PDU session to be released in the network slice.

6. The method of claim 1, wherein the first AMF is a new AMF for the UE and the second AMF is an old AMF for the UE.

7. The method of claim 6, further comprising:
transmitting, to the second AMF, a request message for a transfer of the UE context; and
receiving, from the second AMF, a response message for the transfer of the UE context, the response message including the UE context and a UE ID.

8. A method performed by a second access and mobility management function (AMF) in a wireless communication system, the method comprising:
identifying that a user equipment (UE) moves to a cell where a replaced single network slice selection assistance information (S-NSSAI) is not supported; and
based on the replaced S-NSSAI being not supported, receiving, from a first AMF, a registration status update message indicating a registration status for a UE context, wherein the registration status update message includes information on protocol data unit (PDU) session identifier (ID) to be released.

9. The method of claim 8, wherein the replaced S-NSSAI is removed from an allowed NSSAI in case that the UE moves to the cell where the replaced S-NSSAI is not supported.

10. The method of claim 8, wherein the first AMF is a new AMF for the UE and the second AMF is an old AMF for the UE.

11. The method of claim 10, further comprising:
receiving, from the first AMF, a request message for a transfer of the UE context; and
transmitting, to the first AMF, a response message for the transfer of the UE context, the response message including the UE context and a UE ID.

12. A first access and mobility management function (AMF) in a wireless communication system, the first AMF comprising:
a transceiver; and
a controller coupled with the transceiver and configured to:
identify that a user equipment (UE) moves to a cell where a replaced single network slice selection assistance information (S-NSSAI) is not supported, and
based on the replaced S-NSSAI being not supported, transmit, to a second AMF, a registration status update message indicating a registration status for a UE context, wherein the registration status update message includes information on protocol data unit (PDU) session identifier (ID) to be released.

13. The first AMF of claim 12, wherein the controller is further configured to:
remove the replaced S-NSSAI from an allowed NSSAI in case that the UE moves to the cell where the replaced S-NSSAI is not supported.

14. The first AMF of claim 13, wherein the controller is further configured to:
remove an alternative S-NSSAI from the allowed NSSAI in case that the replaced S-NSSAI is not maintained in the allowed NSSAI.

15. The first AMF of claim 12, wherein the controller is further configured to:
based on processing at least one PDU session included in a network slice for service continuity, determine a PDU session to be released in the network slice among the at least one PDU session, and
transmit, to a session management function (SMF), a release request message including the PDU session ID corresponding to the PDU session to be released in the network slice.

16. The first AMF of claim 12, wherein the first AMF is a new AMF for the UE and the second AMF is an old AMF for the UE.

17. The first AMF of claim 16, wherein the controller is further configured to:
transmit, to the second AMF, a request message for a transfer of the UE context; and
receive, from the second AMF, a response message for the transfer of the UE context, the response message including the UE context and UE ID.

18. A second access and mobility management function (AMF) in a wireless communication system, the second AMF comprising:
a transceiver; and
a controller coupled with the transceiver and configured to:
identify that a user equipment (UE) moves to a cell where a replaced single network slice selection assistance information (S-NSSAI) is not supported, and
based on the replaced S-NSSAI being not supported, receive, from a first AMF, a registration status update message indicating a registration status for a UE context, wherein the registration status update message includes information on protocol data unit (PDU) session identifier (ID) to be released.

19. The second AMF of claim 18, wherein the replaced S-NSSAI is removed from an allowed NSSAI in case that the UE moves to the cell where the replaced S-NSSAI is not supported.

20. The second AMF of claim 18, wherein the first AMF is a new AMF for the UE and the second AMF is an old AMF for the UE.
